(19) United States
(12) Patent Application Publication
(10) Pub. No.: US 2023/0048838 A1
(43) Pub. Date: Feb. 16, 2023

(54) MERCHANDISE TRANSACTION PROCESSING SYSTEM, SETTLEMENT APPARATUS, AND PROGRAM FOR SETTLEMENT APPARATUS

(71) Applicant: TOSHIBA TEC KABUSHIKI KAISHA, Tokyo (JP)

(72) Inventor: Hiroyuki KATSUMATA, Numazu Shizuoka (JP)

(21) Appl. No.: 17/749,866

(22) Filed: May 20, 2022

(30) Foreign Application Priority Data
Aug. 11, 2021 (JP) 2021-131238

(51) Int. Cl. G06Q 20/20

(52) U.S. Cl. CPC G06Q 20/202; G06Q 20/204

(57) ABSTRACT

According to an embodiment, a transaction settlement apparatus includes a communication interface connectable, to a clerk-operated register machine and at least one other transaction settlement apparatus. A processor of the apparatus operates as a master device or a satellite device. When operating as the master device, the processor is configured to receive settlement information from the register machine, perform settlement processing according to the settlement information when available for settlement processing, and transfer the settlement information to another settlement apparatus when unavailable. When operating as the satellite device, the processor is configured to receive the settlement information transferred from another settlement apparatus, perform settlement processing according to the transferred settlement information when available for settlement processing, and transmit a busy notification to the register machine if unavailable for settlement processing.

### CROSS-REFERENCE TO RELATED APPLICATION

This application is based upon and claims the benefit of priority from Japanese Patent Application No. 2021-131238, filed Aug. 11, 2021, the entire contents of which are incorporated herein by reference.

### FIELD

Embodiments described herein relate generally to a transaction processing system for handling retail merchandise transactions, a settlement apparatus for a transaction processing system, and a program for a settlement apparatus in a transaction processing system.

### BACKGROUND

In recent years, a semi-self-service type of a transaction processing system has been adopted by larger retailers. In a transaction processing system of this type, there is an input processing apparatus registers data regarding items being purchased in a sales transaction and a separate settlement apparatus that handles payments for the transaction based on the data registered by the input processing apparatus. The input processing apparatus and the settlement apparatus are disposed such that a store clerk operates the input processing apparatus and a customer operates the settlement apparatus.

In the transaction processing system of this semi-self-service type, since the store clerk performs the data input operation for items being purchased, the time required for registration is generally reduced as compared to a full self-service type system in which the customer performs both the registration and settlement operations by himself or herself.

On the other hand, in a semi-self service type system, since a customer still operates a settlement apparatus by himself or herself, it may be common for a customer unaccustomed to such operations to take a long time to complete a settlement operation. Therefore, in general, the semi-self-service type transaction includes more than one settlement apparatus for each input processing apparatus. As such, one settlement apparatus must typically be set as a master machine the other settlement apparatus (or apparatuses) set as a satellite machine.

The input processing apparatus transmits information necessary for the settlement of a transaction to the master machine. If settlement for the preceding customer is already finished and settlement processing is possible, the master machine processes the settlement of the transaction. If the settlement for the preceding customer is still on-going and the settlement processing is not presently possible, the master machine transmits the information necessary for the settlement to a satellite machine. The satellite machine processes the settlement of the transaction based on the information received from the master machine. In this way, the transaction processing system of the semi-self-service type of related art permits the two settlement apparatuses to efficiently operate to make it possible to settle many transactions in a short time.

However, the possible transmission destination to which the input processing apparatus directly transmits the information necessary for the settlement of the transaction is limited to just the master machine in such a case. Therefore, if the master machine breaks down and can no longer receive the information necessary for processing a settlement, the satellite machine may also not be able to process the settlement since the inoperable master machine might not be able to forward the necessary settlement information to the satellite.

### BRIEF DESCRIPTION OF THE DRAWINGS

FIG. 1 is a schematic diagram illustrating a schematic configuration of a transaction processing system according to an embodiment.

FIG. 2 is a schematic diagram illustrating a main data structure of settlement information.

FIG. 3 is a block diagram illustrating a configuration of a registration machine.

FIG. 4 is a block diagram illustrating a configuration of a checkout machine.

FIG. 5 is a block diagram illustrating a configuration of a proxy apparatus.

FIG. 6 is a flowchart of first information processing executed by a processor of a registration machine according to a registration program.

FIG. 7 is a flowchart of first information processing executed by a processor of a registration machine according to a registration program.

FIG. 8 is a flowchart of second information processing executed by a processor of a master machine according to a settlement program.

FIG. 9 is a flowchart of settlement processing.

FIG. 10 is a flowchart of third information processing executed by a processor of a satellite machine according to a settlement program.

FIG. 11 is a sequence chart when a master machine is capable of executing settlement processing.

FIG. 12 is a sequence chart when a master machine incapable of executing settlement processing.

FIG. 13 is a sequence chart when neither a master machine nor a satellite machine is capable of executing settlement processing.

FIG. 14 is a sequence chart when a master machine incapable of executing settlement processing receives a transaction file and transferring of the transaction file to a satellite machine fails.

FIG. 15 is a sequence chart when a transmitting of a transaction file to a master machine from a registration machine fails.

FIG. 16 is an example of a registration screen displayed on a registration machine.

FIG. 17 is an example of a subtotal screen displayed on a registration machine.

FIG. 18 is an example of a checkout destination notification screen displayed on a registration machine.

FIG. 19 is an example of a transmission error screen displayed on a registration machine.

FIG. 20 is an example of a payment method selection screen displayed on a checkout machine.

FIG. 21 is an example of a cash settlement screen displayed on a checkout machine.

FIG. 22 is an example of an error receipt.

FIG. 23 is a flowchart of fourth information processing executed by a processor of a satellite machine according to a settlement program.

FIG. 24 is a flowchart of sixth information processing executed by a processor of a proxy apparatus according to a proxy program.

FIG. 25 is a flowchart of fifth information processing executed by a processor of a satellite machine according to a settlement program.

### DETAILED DESCRIPTION

A problem addressed by certain embodiments is to prevent a settlement from being delayed in a transaction processing system when a settlement apparatus (checkout machine) is unable to receive a transmission of settlement information from an input processing apparatus (a registration machine).

According to an embodiment, a transaction settlement apparatus includes a communication interface connectable, via a network, to a clerk-operated register machine and at least one other transaction settlement apparatus. A processor of the transaction settlement apparatus is configured to operate as a master device or a satellite device. When operating as the master device, the processor is configured to: receive settlement information from the clerk-operated register machine, perform settlement processing according to the received settlement information when available for settlement processing, and transfer the received settlement information to another settlement apparatus when unavailable for settlement processing. When operating as the satellite device, the processor is configured to: receive the settlement information transferred from another settlement apparatus, perform settlement processing according to the transferred settlement information when available for settlement processing, and transmit a busy notification to the clerk-operated register machine if unavailable for settlement processing when the settlement information is transferred from another settlement apparatus.

As one example, a transaction processing system of a semi-self-service type is explained below with reference to the drawings as one example.

A transaction processing system of the semi-self-service type includes an input processing apparatus and a settlement apparatus. The input processing apparatus is an apparatus for registering commodity sales data. The settlement apparatus is an apparatus for acquiring, from the input processing apparatus, information necessary for settlement of the transaction. In the embodiment explained below, the input processing apparatus is referred to as registration machine and the settlement apparatus is referred to as a checkout machine.

### Configuration of a Transaction Processing System

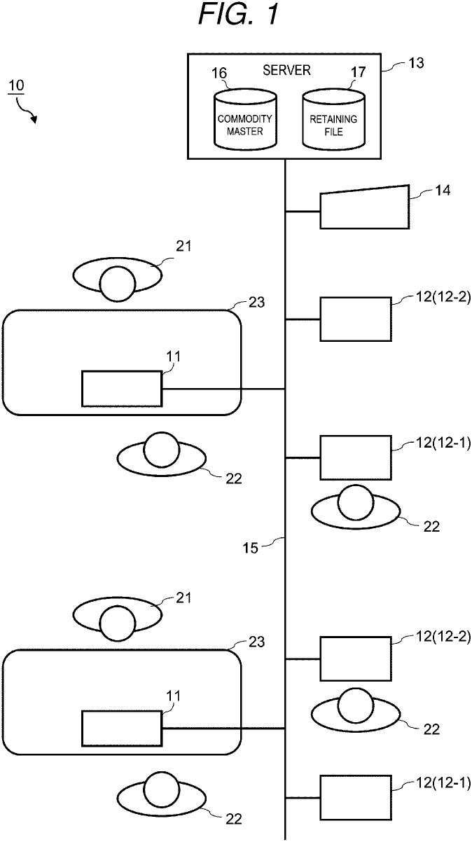

First, the configuration of a transaction processing system 10 according to this embodiment is explained with reference to FIGS. 1 to 5.

FIG. 1 is a schematic diagram of the transaction processing system 10. The transaction processing system 10 includes a registration machine 11, a checkout machine 12, a server 13, a proxy apparatus 14, and a network 15 connecting the foregoing. The type of the network 15 is not particularly limited. However, in general, a wired or wireless LAN (local area network) is applied.

A store clerk 21 (assuming a role called a checker) is an operator of the registration machine 11. A consumer who purchases commodities in the store, a so-called customer 22, is an operator of the checkout machine 12. In FIG. 1, the registration machine 11 is attached to a work table 23. The work table 23 includes a rectangular top plate. A plurality of work tables 23 are disposed such that the longitudinal directions are substantially parallel, whereby a passage for the customer 22, a so-called checkout lane is formed.

A registration machine 11 and at least one checkout machine 12 are disposed for each checkout lane of the store. As depicted, a plurality of checkout machines 12 are disposed for each checkout lane. Various data signals are exchanged, via the network 15, between the registration machine 11 and the checkout machines 12 of the same checkout lane. The data signals may be exchanged via the server 13 or may be exchange by another route not including the server 13.

In FIG. 1, an example is illustrated in which one registration machine 11 and two checkout machines 12 are disposed for each checkout lane. Of the two checkout machines 12 for each lane, one checkout machine 12-1 is set as a master machine and the other checkout machine 12-2 is set as a satellite machine. Operations of the master machine 12-1 and the satellite machine 12-2 are explained below.

In the following, if a checkout machine 12 is not being particularly distinguished as a master machine or a satellite machine, both types can be described as a “checkout machine 12”. If the checkout machine 12 is being distinguished by particular type in the description, it will be described as a “master machine 12-1” or a “satellite machine 12-2”.

The server 13 includes a commodity master file 16 and a retaining file 17. The commodity master file 16 and the retaining file 17 may be saved in a storage device incorporated in the server 13 or may be saved in a storage device connected externally to the server 13.

The commodity master file 16 is a data file that stores a commodity record created for each of commodities sold in the store. The commodity record is a data record describing commodity data such as a commodity code, a commodity name, a unit price, and an attribute.

The commodity code is a specific (unique) code set in order to identify different commodities or commodity types. Usually, barcodes or two-dimensional codes representing commodity codes are attached to the commodities being sold at the store. Alternatively, RFID (Radio Frequency Identification) tags storing the commodity codes may be attached to the commodities. The registration machine 11 can receive a commodity code of a commodity being purchased in a transaction by reading, with a reading device, a barcode, a two-dimensional code, or an RFID tag attached to the commodity.

A commodity name and unit price are identified by association with the commodity code. Additional information or attributes may be associated with the commodity code of a product. For example, information concerning a tax treatment of the item associated with the commodity code may be provided. The information concerning the tax treatment includes, for example, a tax rate and a tax type (e.g., an exclusive tax, an inclusive tax, or tax free).

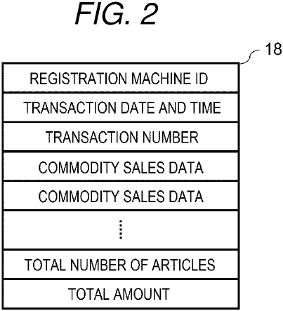

The retaining file 17 is a region for temporarily retaining a transaction file created in the registration machine 11. The transaction file is a data file describing settlement information 18 (see FIG. 2), which is necessary for settlement of a transaction.

FIG. 2 is a schematic diagram illustrating a main data structure of the settlement information 18. As illustrated, the settlement information 18 includes items such as a transaction number, a transaction date and time, a registration machine ID, commodity sale data, a total number of articles, and a total amount. The transaction number is a serial number issued for each transaction in order to individually identify a transaction with the customer 22. The transaction date and time is a date and time when the transaction was performed. The registration machine ID is identification information set for the registration machine 11 that processed the transaction. Specific registration machine IDs are set for the registration machines 11. The commodity sales data includes items such as a commodity code, a commodity name, a unit price, the number of sold articles, a sales amount, and an attribute of a commodity purchased by the customer 22. The settlement information 18 includes commodity sale data of all commodities purchased by the customer 22 in the transaction. The total number of articles is obtained by adding up the numbers of sold articles in the transaction. The total amount is obtained by adding up sales amounts of the commodity sales data in the transaction.

The settlement information 18 is uniquely specified by a transaction number, a transaction date and time, and a registration machine ID. That is, the transaction number, the transaction date and time, and the registration machine ID function as transaction specifying information for specifying the particular settlement information 18 from among others if present. The transaction specifying information is not limited to the transaction number, the transaction date and time, and the registration machine ID. So long as the settlement information 18 can be identified, other items of information may be added items may be omitted. The data structure of the settlement information 18 is not limited to the data structure illustrated in FIG. 2. Other items may be added or items omitted.

Referring back to FIG. 1, the proxy apparatus 14 is an apparatus that executes, in place of the checkout machine 12, the settlement of the transaction, the commodity sales data of which is registered by the registration machine 11. Usually, the proxy apparatus 14 is set not in the checkout lane but is set at, for example, a service counter of the store.

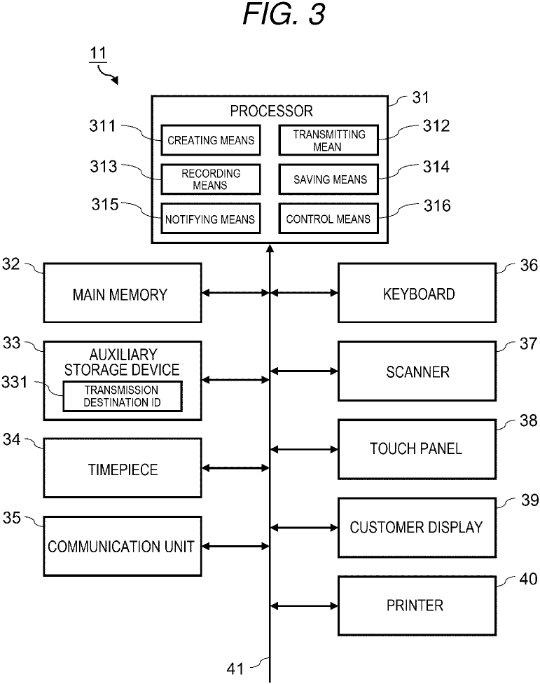

FIG. 3 is a block diagram illustrating a configuration of the registration machine 11. The registration machine 11 includes a processor 31, a main memory 32, an auxiliary storage device 33, a timepiece 34, a communication unit 35, a keyboard 36, a scanner 37, a touch panel 38, a customer display 39, a printer 40, and a system transmission line 41. The system transmission line 41 includes an address bus, a data bus, and a control signal line. The system transmission line 41 connects the processor 31 and the other units directly or via a signal input and output circuit and transmits data signals exchanged between the processor 31 and the other units.

The registration machine 11 comprises a computer including the processor 31, the main memory 32, the auxiliary storage device 33, the timepiece 34, and the communication unit 35, which are connected via the system transmission line 41 or the like. In the registration machine 11, devices such as the keyboard 36, the scanner 37, the touch panel 38, the customer display 39, and the printer 40 can be connected via the system transmission line 41.

The processor 31 controls the components in order to realize various functions of the registration machine 11 according to an operating system or application programs. The processor 31 is, for example, a CPU (Central Processing Unit).

The main memory 32 includes a nonvolatile memory region and a volatile memory region. The main memory 32 stores an operating system or application programs in the nonvolatile memory region. The main memory 32 sometimes stores, in the nonvolatile or volatile memory region, data necessary for the processor 31 in executing processing for controlling the various components or sub-units. The main memory 32 uses the volatile memory region as a work area where data is rewritten as appropriate by the processor 31. The nonvolatile memory region is, for example, a ROM (Read Only Memory). The volatile memory region is, for example, a RAM (Random Access Memory).

For example, an EEPROM (Electric Erasable Programmable Read-Only Memory), a HDD (Hard Disk Drive), or an SSD (Solid-State Drive) can be used as the auxiliary storage device 33. The auxiliary storage device 33 saves data used by the processor 31, data generated by the processing of the processor 31, and the like. The auxiliary storage device 33 sometimes stores application programs.

The timepiece 34 provides a date and time. The processor 31 processes the date and the time from the timepiece 34 as the present date and time.

The communication unit 35 performs data communication with the server 13 and the checkout machine 12 in the same checkout lane connected via the network 15. The communication unit 35 can also perform data communication with the registration machine 11 or the checkout machine 12 in another checkout lane or the proxy apparatus 14 connected via the network 15.

The keyboard 36 is an input device on which various keys necessary for, for example, an input of data relating to a commodity purchased by the customer 22.

The scanner 37 is an example of a reading device capable of reading a code symbol such as a barcode or a two-dimensional code. The scanner 37 may be a type for reading the code symbol by scanning with laser light or may be a type for reading the code symbol from an image captured by an imaging device.

The touch panel 38 is equipment functioning as both of an input device and a display device. The touch panel 38 displays information to the store clerk 21, who is the operator of the registration machine 11 and receives an operation input by the store clerk 21.

The customer display 39 displays information to the customer 22, whose data of purchased commodities is registered in the registration machine 11.

The printer 40 dispenses a receipt by printing various character strings, images, or the like on receipt paper. As the printer 40 of this type, for example, a thermal printer or a dot impact printer can be used.

As hardware of such a registration machine 11, an existing POS terminal can be used. Devices connected to the registration machine 11 are not limited to the keyboard 36, the scanner 37, the touch panel 38, the customer display 39, and the printer 40 such as illustrated in FIG. 3. Devices may be added or omitted.

The registration machine 11 uses the auxiliary storage device 33 as a storing unit 331 for a transmission destination ID. The transmission destination ID is information identifying a checkout machine 12 that is a transmission destination for the settlement information 18. Specific checkout machine IDs are respectively set in advance in each of the checkout machines 12. As a default, the registration machine 11 stores the checkout machine ID of master machine 12-1 as the transmission destination ID.

In the registration machine 11, the processor 31 provides the functions of a creating unit 311, a transmitting unit 312, a recording unit 313, a saving unit 314, a notifying unit 315, and a control unit 316. The creating unit 311 generates the settlement information 18 necessary for settlement of a transaction based on registered commodity data input via the reading device or the input device. The transmitting unit 312 transmits a transaction file describing the settlement information 18 to the particular checkout machine 12 matching the transmission destination ID stored in the storing unit 331.

The recording unit 313 can provide a record corresponding to the transaction file if transmission of the transaction file to the selected checkout machine 12 experiences an error or the. The record provided by the recording unit 311 can be handed to the customer 22. The record is provided, for example, as receipt paper. In this embodiment, a barcode symbol representing a transaction number (ID), a transaction date and time, and a registration machine ID is printed on the receipt paper by a printer 69. The saving unit 314 saves the transaction file if there is an error in the transmission to the checkout machine 12. The saving unit 314 saves the transaction file in the retaining file 17 of the server 13.

The notifying unit 315 provides a notification of a transmission error to the operator when a transmission error occurs. The control unit 316 can receive a confirmation operation from the operator in response to the notification of the transmission error. If control unit 316 can cause the saving unit 314 to save the transaction file and the recording medium 313 to record the transaction file on a medium after the confirmation operation is performed.

All of the functions of the creating unit 311, the transmitting unit 312, the recording unit 313, the saving unit 314, the notifying unit 315, and the control unit 316 are realized by first information processing executed by the processor 31 according to a registration program. The first information processing is explained below.

The registration program is a type of application program stored in the main memory 32 or the auxiliary storage device 33. The method of installing the registration program in the main memory 32 or the auxiliary storage device 33 is not particularly limited. The registration program can be installed in the main memory 32 or the auxiliary storage device 33 by being recorded in a removable recording medium or by being distributed by communication via the network 15. The recording medium may be any form that can store a program and can be read by a device like a CD-ROM, a memory card, or the like.

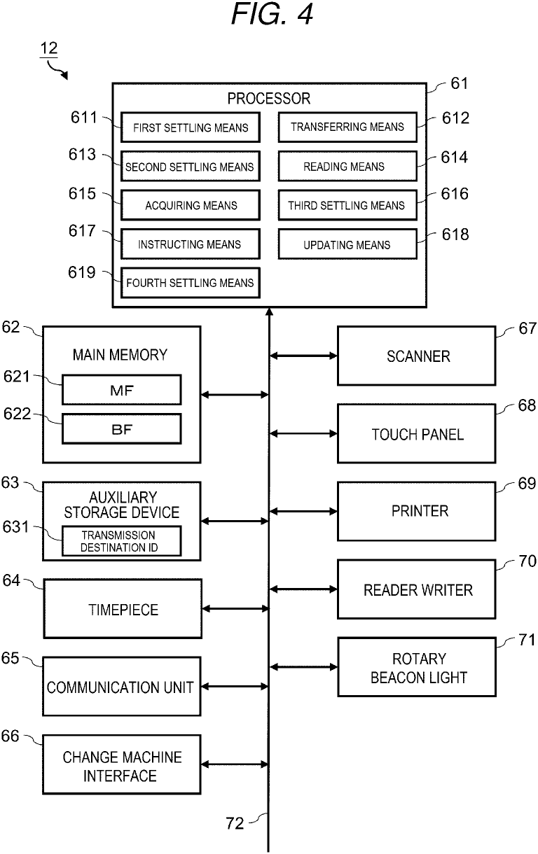

FIG. 4 is a block diagram illustrating a configuration of the checkout machine 12. Since the master machine 12-1 and the satellite machine 12-2 have the same circuit configuration, the master machine 12-1 and the satellite machine 12-2 are not distinguished in FIG. 4 and explained as the checkout machine 12.

The checkout machine 12 includes a processor 61, a main memory 62, an auxiliary storage device 63, a timepiece 64, a communication unit 65, a change machine interface 66, a scanner 67, a touch panel 68, a printer 69, a reader-writer 70, a rotary beacon light 71, and a system transmission line 72. The system transmission line 72 includes an address bus, a data bus, and a control signal line. The system transmission line 72 connects the processor 61 and the other units directly or via a signal input and output circuit and transmits data signals exchanged between the processor 61 and the other units.

The checkout machine 12 comprises computer including the processor 61, the main memory 62, the auxiliary storage device 63, the timepiece 64, and the communication unit 65, which are connected via the system transmission line 72. In the checkout machine 12, a device interface and devices such as the change machine interface 66, the scanner 67, the touch panel 68, the printer 69, the reader-writer 70, and the rotary beacon light 71 can be connected via the system transmission line 72.

The processor 61 controls the components in order to realize various functions of the checkout machine 12 according to an operating system or application programs. The processor 61 is, for example, a CPU.

The main memory 62 includes a nonvolatile memory region and a volatile memory region. The main memory 62 stores an operating system or application programs in the nonvolatile memory region. The main memory 62 sometimes stores, in the nonvolatile or volatile memory region, data necessary for the processor 61 for controlling the various components or sub-units. The main memory 62 uses the volatile memory region as a work area where data can be rewritten as appropriate by the processor 61. The nonvolatile memory region is, for example, a ROM. The volatile memory region is, for example, a RAM.

The For example, an EEPROM, a ROM, a HDD, or an SSD can be the auxiliary storage device 63. The auxiliary storage device 63 saves data used by the processor 61, data created by the processing of the processor 61, and the like. The auxiliary storage device 63 sometimes stores application programs.

The timepiece 64 provides a date and time. The processor 61 processes the date and the time from the timepiece 64 as the present date and time.

The communication unit 65 performs data communication with the server 13 or the registration machine 11 in the same checkout lane connected via the network 15. The communication unit 65 can also perform data communication with the registration machine 11 or the checkout machine 12 in another checkout lane or the proxy apparatus 14 connected via the network 15.

The change machine interface 66 connects to an automatic change machine. The change machine interface 66 receives, from the automatic change machine, an amount of money deposited into the automatic change machine. The change machine interface 66 outputs change data from the checkout machine 12 to the automatic change machine. The automatic change machine automatically dispenses money as change in accordance with the change data from the checkout machine 12.

The scanner 67 is an example of a reading device that reads a code symbol, such as a barcode or a two-dimensional code. The scanner 67 may be a type for reading the code symbol by scanning with laser light or may be a type for reading the code symbol from an image captured by an imaging device.

The touch panel 68 functions as both of an input device and a display device. The touch panel 68 displays information to the customer 22 and receives an input operation from the customer 22.

The printer 69 dispenses a receipt by printing various character strings, images, or the like on receipt paper. As the printer 69 of this type, for example, a thermal printer or a dot impact printer can be used.

The reader-writer 70 reads data recorded in a medium such as a data storage card or a smartphone and writes data to the medium. The data storage card can be a member card called member’s card or point card instead of, in addition to, cards for settlement such as a credit card, a debit card, an electronic money card, and a prepaid card. The reader-writer 70 may be a device of a magnetic type, a contact type, or a noncontact type or may include a plurality of types of devices.

The rotary beacon light 71 includes, for example, light emitting bodies that emit two colors, for example, red and blue. The rotary beacon light 71 is provided at the top of a pole erected near the checkout machine 12 to be associated with the checkout machine 12. The rotary beacon light 71 lights or flashes in, for example, red or blue according to a state of the checkout machine 12 corresponding to the rotary beacon light 71.

As hardware of such a checkout machine 12, for example, a POS terminal in an existing transaction processing system of the full self-service type, a so-called self-service register can be used. Devices connected to the checkout machine 12 are not limited to the scanner 67, the touch panel 68, the printer 69, the reader-writer 70, and the rotary beacon light 71 illustrated in FIG. 4. Devices necessary in a use of the checkout machine 12 may be added or a part of the devices may be omitted.

The checkout machine 12 uses a part of a storage region of the main memory 62 as a storage region 621 for a mode flag MF and a storage region 622 for a busy flag BF. The mode flag MF is one-bit data for identifying an operation mode of the checkout machine 12. As the operation mode, there are a master mode and a satellite mode. The master mode is an operation mode for the master machine 12-1. The satellite mode is an operation mode for the satellite machine 12-2. That is, the checkout machine 12 set to the master mode is the master machine 12-1. Similarly, the checkout machine 12 set to the satellite mode is the satellite machine 12-2. In this embodiment, the mode flag MF representing the maser mode is set to “1” and the mode flag MF representing the satellite mode is set to “0”.

The busy flag BF is one-bit data for identifying whether the checkout machine 12 is performing settlement processing. In this embodiment, the busy flag BF indicating that the checkout machine 12 is performing the settlement processing is set to “1,” and the busy flag BF indicating that the checkout machine 12 is not performing the settlement processing is set to “0”.

The checkout machine 12 uses a part of a storage region of the auxiliary storage device 63 as a storing unit 631 for a transfer destination ID. The transfer destination ID is information for identifying another checkout machine 12 that is a transfer destination of a transaction file describing the settlement information 18. As default, the master machine 12-1 stores a checkout machine ID of the satellite machine 12-2 disposed in the same checkout lane as the transfer destination ID in the storing unit 631. Since a transfer destination of the transfer file is absent, as default, the satellite machine 12-2 stores a Null value in the storing unit 631.

In the checkout machine 12, the processor 61 provides the functions of a first settling unit 611, a transferring unit 612, a second settling unit 613, a reading unit 614, an acquiring unit 615, a third settling unit 616, an instructing unit 617, an updating unit 618, and a fourth settling unit 619. The first settling unit 611 and the transferring unit 612 are functions of the checkout machine 12 operating in the master mode, that is, a master machine 12-1. The second settling unit 613, the reading unit 614, the acquiring unit 615, the third settling unit 616, the instructing unit 617, the updating unit 618, and the fourth settling unit 619 are functions of the checkout machine 12 operating in the satellite mode, that is, a satellite machine 12-2.

The first settling unit 611 receives a transaction file via the network 15 from the registration machine 11 disposed in the same checkout lane when settlement processing is executable. The master machine 12-1 executes settlement processing based on the settlement information 18 described in the transaction file. The transferring unit 612 transmits the transaction file to the checkout machine 12 identified by a transfer ID stored in the storing unit 631 (that is, the satellite machine 12-2 disposed in the same checkout lane).

The second settling unit 613 executes settlement processing based on settlement information of a transaction file received from the master machine 12-1.

The reading unit 614 reads transaction specifying information recorded in a medium. In this embodiment, a barcode symbol representing the transaction specifying information is printed on receipt paper and handed to the customer 22. Therefore, the reading unit 614 reads the barcode symbol with the scanner 67. The acquiring unit 615 acquires, from the retaining file 17, the settlement information 18 corresponding to the transaction specifying information read by the reading unit 614. The third settling unit 616 executes settlement processing based on the settlement information 18 acquired by the acquiring unit 615.

The instructing unit 617 instructs the registration machine 11 disposed in the same checkout lane to switch a transmission destination for settlement information from the master machine 12-1 to the satellite machine 12-2. The updating unit 618 updates the mode flag MF from “0” (representing the satellite mode) to “1” (representing the master mode) if a permission response is received from the registration machine 11. The fourth settling unit 619 executes settlement processing based on the settlement information 18 described in the transaction file. The fourth settling unit can be referred to as a post-switching settling unit.

All of the functions of the first settling unit 611, the transferring unit 612, the second settling unit 613, the reading unit 614, the acquiring unit 615, the third settling unit 616, the instructing unit 617, the updating unit 618, and the fourth settling unit 619 are realized by second information processing, third information processing, fourth information processing, and fifth information processing executed by the processor 61 according to a settlement program. The second information processing, the third information processing, the fourth information processing, and the fifth information processing are explained below.

The settlement program is a type of application program stored in the main memory 62 or the auxiliary storage device 63. A method of installing the settlement program in the main memory 62 or the auxiliary storage device 63 is not particularly limited. The settlement program can be installed in the main memory 62 or the auxiliary storage device 63 by being recorded in a removable recording medium or being distributed by communication via the network 15. A form of the recording medium may be any form if the recording medium can store a program and can be read by a device like a CD-ROM, a memory card, or the like.

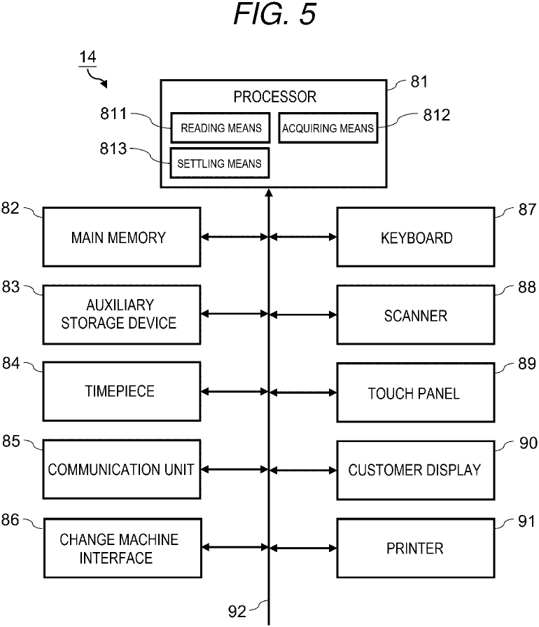

FIG. 5 is a block diagram illustrating a configuration of the proxy apparatus 14. The proxy apparatus 14 includes a processor 81, a main memory 82, an auxiliary storage device 83, a timepiece 84, a communication unit 85, a change machine interface 86, a keyboard 87, a scanner 88, a touch panel 89, a customer display 90, a printer 91, and a system transmission line 92. The system transmission line 92 includes an address bus, a data bus, and a control signal line. The system transmission line 92 connects the processor 81 and the other units directly or via a signal input and output circuit and transmits data signals exchanged between the processor 81 and the other units.

The proxy apparatus 14 comprises a computer including the processor 81, the main memory 82, the auxiliary storage device 83, the timepiece 84, and the communication unit 85, which are connected via the system transmission line 92. In the proxy apparatus 14, a device interface and devices such as the change machine interface 86, the keyboard 87, the scanner 88, the touch panel 89, the customer display 90, and the printer 91 can be connected via the system transmission line 92.

The processor 81 controls the various components and sub-units in order to realize various functions of the proxy apparatus 14 according to an operating system or application programs. The processor 81 is, for example, a CPU.

The main memory 82 includes a nonvolatile memory region and a volatile memory region. The main memory 82 stores an operating system or application programs in the nonvolatile memory region. The main memory 82 sometimes stores, in the nonvolatile or volatile memory region, data necessary for the processor 81 in executing processing for controlling the units. The main memory 82 uses the volatile memory region as a work area where data is rewritten as appropriate by the processor 81. The nonvolatile memory region is, for example, a ROM. The volatile memory region is, for example, a RAM.

For example, an EEPROM, a HDD, or an SSD can be the auxiliary storage device 83. The auxiliary storage device 83 saves data used by the processor 81 in executing various kinds of processing, data created by the processing of the processor 81, and the like. The auxiliary storage device 83 sometimes stores application programs.

The timepiece 84 provides a date and time. The processor 81 processes the date and the time from the timepiece 84 as the present date and time.

The communication unit 85 performs data communication with the server 13 connected via the network 15. The communication unit 85 can also perform data communication with the registration machines 11 or the checkout machines 12 in the checkout lanes connected via the network 15.

The change machine interface 86 connects to an automatic change machine. The change machine interface 86 receives, from the automatic change machine, an amount data of money deposited into the automatic change machine. The change machine interface 86 outputs change data from the proxy apparatus 14 to the automatic change machine. The automatic change machine automatically dispenses money as change in accordance with the change data.

As the keyboard 87, the scanner 88, the touch panel 89, the customer display 90, and the printer 91, the same ones as the keyboard 36, the scanner 37, the touch panel 38, the customer display 39, and the printer 40 can be directly used. That is, as hardware of the proxy apparatus 14, for example, the existing POS terminal can be used. Devices connected to the proxy apparatus 14 are not limited to the keyboard 87, the scanner 88, the touch panel 89, the customer display 90, and the printer 91 illustrated in FIG. 5. Devices related to uses of the proxy apparatus 14 may be added or devices may be omitted.

In the proxy apparatus 14 the processor 81 provides the functions of a reading unit 811, an acquiring unit 812, and a settling unit 813.

The reading unit 811 reads transaction specifying information recorded in a medium. That is, the reading unit 811 can read, with the scanner 88, a barcode symbol printed on receipt paper. The acquiring unit 812 acquires, from the retaining file 17, the settlement information 18 specified by the transaction specifying information read by the reading unit 811. The settling unit 813 executes settlement processing based on the settlement information 18 acquired by the acquiring unit 812.

All of the functions of the reading unit 811, the acquiring unit 812, and the settling unit 813 are realized by sixth information processing executed by the processor 81 according to a proxy program. The sixth information processing is explained below.

The proxy program is a type of application program stored in the main memory 82 or the auxiliary storage device 83. The method of installing the proxy program in the main memory 82 or the auxiliary storage device 83 is not particularly limited. The proxy program can be installed in the main memory 62 or the auxiliary storage device 63 by being recorded in a removable recording medium or by being distributed by communication via the network 15. The form of the recording medium may be any form that can store a program and be read by a device like a CD-ROM, a memory card, or the like.

### Operation of the Transaction Processing System

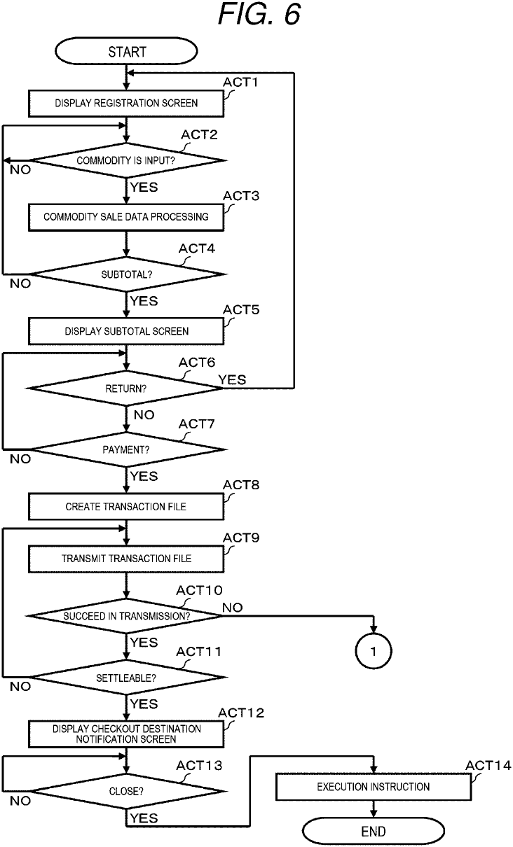

The operation of the transaction processing system 10 is explained with reference to FIGS. 6 to 25. The operation explained below is one example. Aspects of a procedure or processing of the operation can be changed as appropriate so long as the same effects can be achieved.

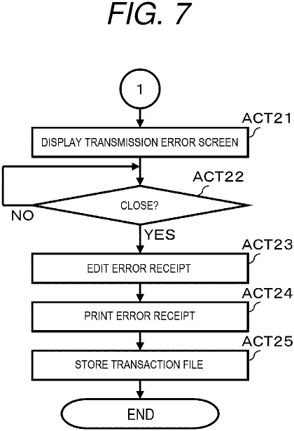

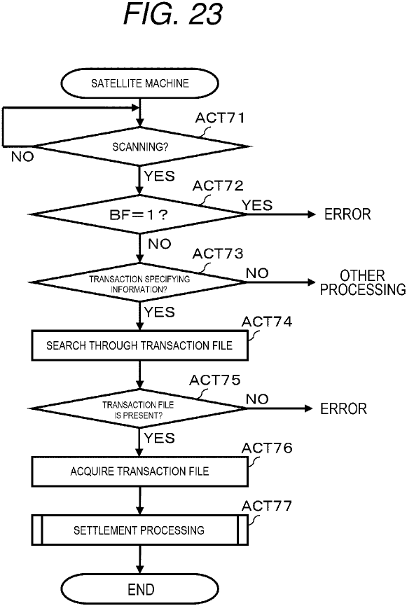

First, a main operation of the registration machine 11 is explained with reference to FIGS. 6 and 7, FIGS. 11 to 19, and FIG. 22. FIGS. 6 and 7 are flowcharts illustrating a procedure of the first information processing executed by the processor 31 of the registration machine 11 according to the registration program. FIGS. 11 to 15 are sequence charts of main data signals exchanged among the registration machine 11, the master machine 12-1, and the satellite machine 12-2. FIGS. 16 to 19 are examples of various screens SCa, SCb, SCc, and SCd displayed on the touch panel 38, which is the display device of the registration machine 11. FIG. 22 is an example of an error receipt RS printed and dispensed by the printer 40 of the registration machine 11.

The customer 22 puts a commodity to be purchased in a shopping basket or the like and goes to a checkout lane. When the customer 22 comes to the checkout lane, the store clerk 21 (assuming the role of the checker) performs an operation for declaring a registration start to the registration machine 11. According to the operation, the registration program of the registration machine 11 starts. The processor 31 starts the first information processing, the procedure of which is illustrated in the flowchart of FIG. 6.

In ACT 1, the processor 31 causes the touch panel 38 to display a registration screen SCa (see FIG. 16).

FIG. 16 is an example of the registration screen SCa. The registration screen SCa is a screen on which a details region ARa and a total region ARb are arranged and an icon of a subtotal button BTa is further arranged. The details region ARa is a region for displaying a commodity name, the number of articles, a unit price, and an amount in a list format in order of serial numbers. Items displayed in the details region ARa are not limited to the commodity name, the number of articles, the unit price, and the amount. Other items may be added or any one of the items, for example, the amount may be omitted. The total region ARb is a region for respectively displaying a total of the numbers of articles (a number of articles) displayed in the details region ARa and a total (yen) of amounts displayed in the details region ARa. Items displayed in the total region ARb are not limited to the total of the numbers of articles and the total of amounts. Other items may be added or any one of the items, for example, the total of the numbers of articles may be omitted. The subtotal button BTa is an operator that the store clerk 21 touches in order to instruct a subtotal output of commodities purchased by the customer 22.

Referring back to FIG. 6, in ACT 2, the processor 31 waits for data relating to a commodity to be input. To most commodities, barcodes representing commodity codes, which are identification information of the commodities, are attached. Therefore, the store clerk 21 operates the scanner 37 and reads a barcode attached to a purchased commodity of the customer 22. The barcode is read by the scanner 37, whereby a commodity code of the purchased commodity is input to the registration machine 11. On the other hand, barcodes are sometimes not attached to a part of commodities such as perishables. If a barcode is not attached to the purchased commodity, the store clerk 21 selects a commodity button corresponding to the purchased commodity out of a group of commodity buttons displayed on the touch panel 38. If a commodity button is selected, a commodity code of the commodity corresponding to the commodity button is input to the registration machine 11.

If the commodity code is input, the processor 31 is determines YES in ACT 2 and proceeds to ACT 3. In ACT 3, the processor 31 executes commodity sales data processing. That is, the processor 31 acquires commodity data such as a commodity name, a unit price, and an attribute from a commodity record of the commodity identified by the commodity code input via the scanner 37 or the touch panel 38. The processor 31 registers commodity sales data including items such as the commodity code, the commodity name, the unit price, the number of sold articles, the sales amount, and the attribute in a transaction memory. The transaction memory is a part of the volatile memory region in the main memory 32.

In ACT 4, the processor 31 checks whether the subtotal button BTa is touched.

The store clerk 21 sequentially performs operation for inputting the commodity code of the purchased commodity of the customer 22. If finishing inputting commodity codes of all purchased commodities, the store clerk 21 touches the subtotal button BTa.

If the subtotal button BTa is not touched and a commodity code of the next commodity is input, the processor 31 determines NO in ACT 4, determines YES in ACT 2, and proceeds to ACT 3. That is, the processor 31 executes the commodity sales data processing. As a result, the commodity sales data of the purchased commodity is registered in the transaction memory.

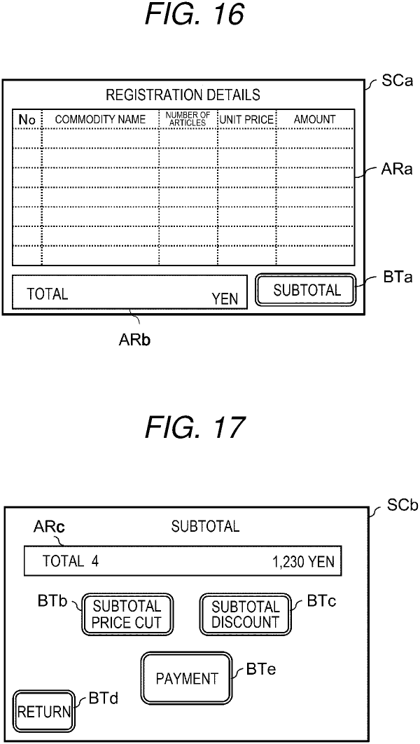

If the subtotal button BTa is touched, the processor 31 determines YES in ACT 4 and proceeds to ACT 5. In ACT 5, the processor 31 causes the touch panel 38 to display a subtotal screen SCb (see FIG. 17).

FIG. 17 is an example of the subtotal screen SCb. The subtotal screen SCb is a screen on which a total region ARc is arranged and icons of a subtotal price-cut button BTb, a subtotal discount button BTc, a return button BTd, and a payment button BTe are further arranged. The total region ARc is the same as the total region ARb of the registration screen SCa. The subtotal price-cut button BTb and the subtotal discount button BTc are operators that the store clerk 21 touches in order to instruct price cut or discount for the total amount. The return button BTd is an operator that the store clerk 21 touches in order to instruct return to the immediately preceding registration screen SCa. The payment button BTe is an operator that the store clerk 21 touches in order to instruct payment of a price.

If all data inputs of commodities purchased by the customer 22 are finished and price cut or discount or other adjustment is unnecessary, the store clerk 21 selects the payment button BTe. If a subtotal price cut or subtotal discount is to be performed, the store clerk 21 selects the subtotal price-cut button BTb or the subtotal discount button BTc. If data input for a purchased commodity still remains to be performed, the store clerk 21 selects the return button BTd.

Referring back to FIG. 6, in ACT 6, the processor 31 checks whether the return button BTd is touched. If the return button BTd is not touched, the processor 31 determines NO in ACT 6 and proceeds to ACT 7. In ACT 7, the processor 31 checks whether the payment button BTe is touched. If the payment button BTe is not touched, the processor 31 determines NO in ACT 7 and returns to ACT 6. In ACT 6 and ACT 7, the processor 31 waits for the return button BTd to be touched or the payment button BTe to be touched. If the subtotal price-cut button BTb or the subtotal discount button BTc is touched in this waiting state, although not illustrated, the processor 31 performs subtotal price-cut processing or subtotal discount processing. Thereafter, the processor 31 returns to the waiting state in ACT 6 and ACT 7.

If the return button BTd is touched by the store clerk 21 in the waiting state in ACT 6 and ACT 7, the processor 31 determines YES in ACT 6 and returns to ACT 1. That is, the processor 31 returns the screen of the touch panel 38 to the registration screen SCa. The processor 31 executes the processing in ACT 2 and subsequent acts in the same manner as explained above.

If the payment button BTe is touched by the store clerk 21 in the waiting state in ACT 6 and ACT 7, the processor 31 determines YES in ACT 7 and proceeds to ACT 8. In ACT 8, the processor 31 creates a transaction file. That is, the processor 31 creates a transaction file describing the settlement information 18 necessary for settlement of a transaction from the commodity sales data of the purchased commodities and the data of the total number of articles and the total amount of the purchased commodities registered in the transaction memory and data capable of specifying the transaction such as a transaction number, a transaction date and time, and a registration machine ID, that is, transaction specifying information. In ACT 9, the processor 31 sets, as a destination, a checkout machine identified by the transmission destination ID set in the storing unit 331 and controls transmission of the transaction file. That is, if, as default, the checkout machine ID of the master machine 12-1 is set in the storing unit 331, the processor 31 sets the master machine 12-1 as a destination and controls the transmission of the transaction file. According to the control, the transaction file is transmitted from the communication unit 35 to the master machine 12-1 in the same checkout lane via the network 15.

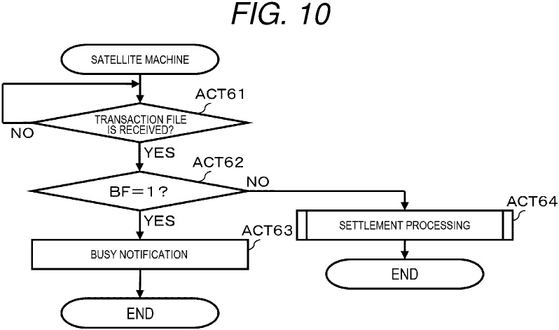

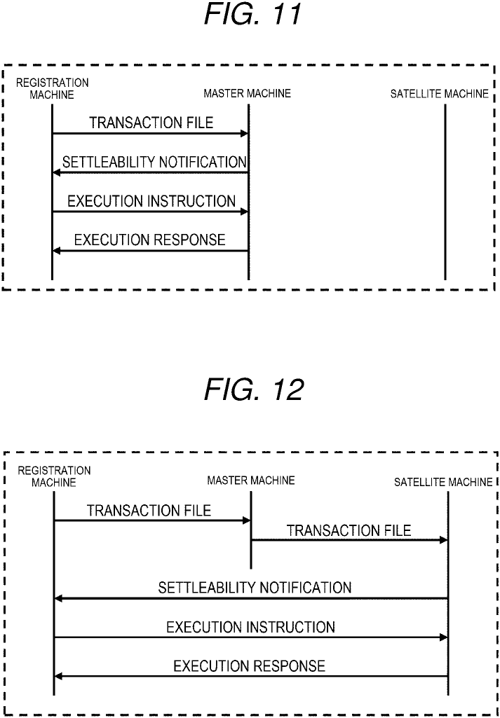

FIG. 11 is a sequence chart at the time when the master machine 12-1 capable of executing settlement processing receives a transaction file. FIGS. 12 to 14 are sequence charts at the time when the master machine 12-1 incapable of executing the settlement processing receives the transaction file. FIG. 15 is a sequence chart at the time when the master machine 12-1 fails in receiving the transaction file.

As illustrated in FIG. 11, if the master machine 12-1 is capable of executing the settlement processing and receives a transaction file, the master machine 12-1 transmits a settleability notification command to the registration machine 11. The registration machine 11 then transmits an execution instruction command to the master machine 12-1. The master machine 12-1 then transmits an execution response command to the registration machine 11.

If the master machine 12-1 is incapable of executing settlement processing and receives a transaction file, as illustrated in FIGS. 12 to 14, the master machine 12-1 transmits a transmission file to the satellite machine 12-2 identified by a transfer destination ID set in the storing unit 631. If the satellite machine 12-2 is capable of executing the settlement processing, as illustrated in FIG. 12, the satellite machine 12-2 transmits a settleability notification command to the registration machine 11. The registration machine 11 then transmits an execution instruction command to the satellite machine 12-2. The satellite machine 12-2 then transmits an execution response command to the registration machine 11.

If the satellite machine 12-2 is incapable of executing the settlement processing, as illustrated in FIG. 13, the satellite machine 12-2 transmits a busy notification command to the registration machine 11.

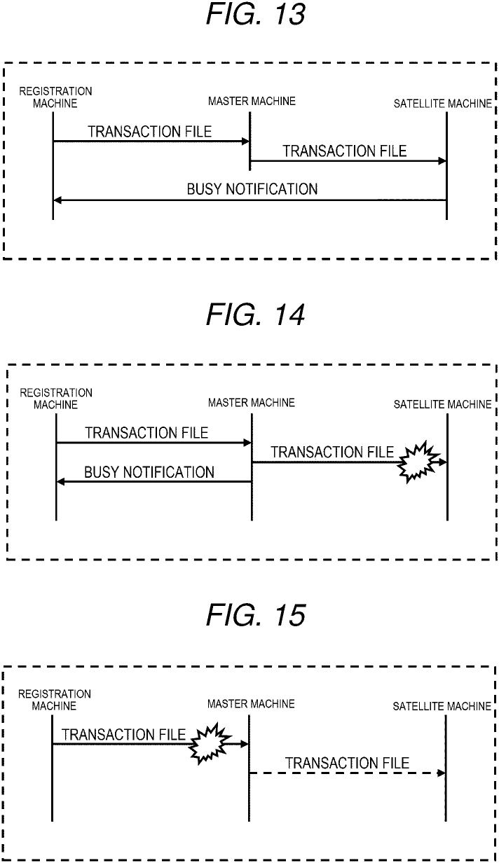

If the transmitting of the transaction file from the master machine 12-1 to the satellite machine 12-2 fails, as illustrated in FIG. 14, the master machine 12-1 transmits a busy notification command to the registration machine 11.

If the transmitting the transaction file to the master machine 12-1 fails, as illustrated in FIG. 15, a notification command is not transmitted from the master machine 12-1 or the satellite machine 12-2 to the registration machine 11. Naturally, a transmission file is not transmitted from the master machine 12-1 to the satellite machine 12-2.

Referring back to FIG. 6, in ACT 10, the processor 31 checks whether the transmission of the transaction file succeeded. After succeeding in the transmission of the transaction file, the processor 31 determines YES in ACT 10 and proceeds to ACT 11. In ACT 11, the processor 31 checks whether the settleability notification command is received. If the settleability notification command is not received but the busy notification command is received from the master machine 12-1 or the satellite machine 12-2, the processor 31 determines NO in ACT 11 and returns to ACT 9. The processor 31 transmits the transmission file to the master machine 12-1 again. For example, if the master machine 12-1 becomes capable of executing the settlement processing upon the retransmission, the settleability notification command is transmitted from the master machine 12-1 to the registration machine 11. If the satellite machine 12-2 becomes capable of executing the settlement processing, the settleability notification command is transmitted from the satellite machine 12-2 to the registration machine 11.

If the settleability notification command is received from the master machine 12-1 or the satellite machine 12-2, the processor 31 determines YES in ACT 11 and proceeds to ACT 12. In ACT 12, the processor 31 causes the touch panel 38 to display a checkout destination notification screen SCc (see FIG. 18).

FIG. 18 is an example of the checkout destination notification screen SCc. An icon of a close button BTf is arranged on the checkout destination notification screen SCc together with a message MSa. The close button BTf is an operator that the store clerk 21 confirming content of the message MSa touches.

The message MSa has content for notifying the store clerk 21 of the checkout machine 12 to which the transaction file is transmitted. The settleability notification command includes a checkout machine ID for identifying the checkout machine 12 that sent the settleability notification command. That is, the settleability notification command transmitted from the master machine 12-1 includes the checkout machine ID of the master machine 12-1, and the settleability notification command transmitted from the satellite machine 12-2 includes the checkout machine ID of the satellite machine 12-2. If the settleability notification command including the checkout machine ID of the master machine 12-1 is received, the message MSa has content identifying the master machine 12-1. If the settleability notification command including the checkout machine ID of the satellite machine 12-2 is received, the message MSa has content for identifying the satellite machine 12-2.

The store clerk 21 then guides the customer 22 to the master machine 12-1 or the satellite machine 12-2 as appropriate according to the message MSa. The store clerk 21 then touches the close button BTf.

In ACT 13, the processor 31 waits for the close button BTf to be touched. If the close button BTf is touched, the processor 31 determines YES in ACT 13 and proceeds to ACT 14. In ACT 14, the processor 31 transmits an execution instruction command to the checkout machine 12 at a settleability notification command transmission source. Then, the processor 31 ends the first information processing at the time when the processor 31 succeeds in the transmission of the transmission file.

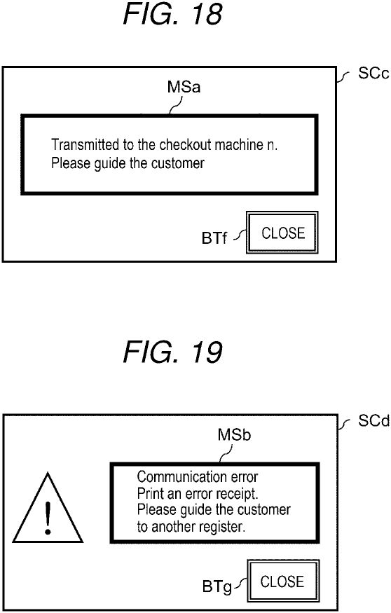

On the other hand, if failing in the transmission of the transmission file, the processor 31 determines NO in ACT 10 and proceeds to ACT 21 in FIG. 7. In ACT 21, the processor 31 causes the touch panel 38 to display a transmission error screen SCd (see FIG. 19).

FIG. 19 is an example of the transmission error screen SCd. An icon of a close button BTg is arranged on the transmission error screen SCd together with a message MSb. The close button BTg is an operator that the store clerk 21 who checked the message MSb touches.

The message MSb has content for notifying the store clerk 21 that the transmission of the transaction file experienced an error, the error receipt RS is printed, and the customer 22 is guided to another register. The error receipt RS is explained below. If the satellite machine 12-2 in the same checkout lane is not in use, the other register to be in use is preferably the satellite machine 12-2 in the lane. The other register may be the proxy apparatus 14 set in a service counter or the like. For example, if the satellite machine 12-2 in an adjacent checkout lane is not in use, the other register to be in use may be the satellite machine 12-2. The store clerk 21 who checked the message MSb touches the close button BTg.

In ACT 22, the processor 31 waits for the close button BTg to be touched. When the close button BTg is selected, the processor 31 determines YES in ACT 22 and proceeds to ACT 23.

In ACT 23, the processor 31 edits the printing data of the error receipt RS. The error receipt RS includes, as illustrated in FIG. 22, a transaction date and time (YYYYMMDD hh:mm), a registration machine ID (a register No. 9999), a transaction number (a transaction No. 9999), and a name (in charge: [person name/ID]) of the store clerk 21, a message MSc for informing that checkout is performed in another register, and a barcode BC. The barcode BC is a representation (e.g., an encoding) of a transaction date and time, a registration machine ID, and a transaction number.

Content of the message MSc is not limited to the content illustrated in FIG. 22. As explained above, the other register is assumed to be a satellite machine 12-2 or a proxy apparatus 14. Therefore, a button for designating whether the other register is the satellite machine 12-2 or the proxy apparatus 14 can be displayed on the transmission error screen SCd instead of the close button BTg. If the store clerk 21 selects the satellite machine 12-2, a message for instructing to perform checkout in the satellite machine 12-2 is displayed on the error receipt RS. If the store clerk 21 selects the proxy apparatus 14, a message for instructing to perform checkout in the proxy apparatus 14 is displayed on the error receipt RS. By adopting such a configuration, even in an abnormal case in which a transaction file is not transmitted from the registration machine 11 to the checkout machine 12, the customer 22 can perform settlement in a designated place without being puzzled. In this case, it is more effective to print, on the error receipt RS, a map or other guidance indicating a place where the satellite machine 12-2 or the proxy apparatus 14 to be used is located.

In ACT 24, the processor 31 starts the printer 40 and causes the printer 40 to print the printing data of the error receipt RS on receipt paper. In ACT 25, the processor 31 saves, in the retaining file 17 of the server 13, via the network 15, the transaction file that the processor 31 failed in transmitting. Then, the processor 31 ends the first information processing at the time when the processor 31 fails in transmitting the transmission file.

In this way, the processor 31 of the registration machine 11 realizes the function of the creating unit 311 according to the processing in ACT 8 in FIG. 6. The processor 31 realizes the function of the transmitting unit 312 according to the processing in ACT 9 in FIG. 6. The processor 31 realizes the function of the recording unit 313 according to the processing in ACT 23 and ACT 24 in FIG. 7. The processor 31 realizes the function of the saving unit 314 according to the processing in ACT 25 in FIG. 7. The processor 31 realizes the function of the notifying mean 315 according to the processing in ACT 21 in FIG. 7. The processor 31 realizes the function of the control unit 316 according to the processing in ACT 22 to ACT 25 in FIG. 7.

With these functions, the registration machine 11 transmits a transaction file describing settlement information to the master machine 12-1 disposed in the same checkout lane. In doing so, if the transmission of the transaction file fails because of a failure of the master machine 12-1, the registration machine 11 causes the touch panel 38 to display the transmission error screen SCd and notifies the store clerk 21 that the registration machine 11 failed in transmitting the transaction file. If the store clerk 21 selects the close button BTg, the registration machine 11 prints and dispenses the error receipt RS with the printer 40. The registration machine 11 also saves, in the retaining file 17 of the server 13, the transaction file that the registration machine 11 failed in transmitting.

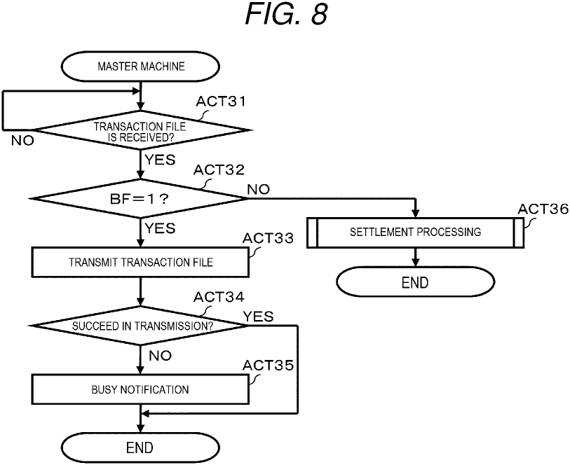

Subsequently, a main operation of the master machine 12-1 is explained with reference to FIGS. 8, 9, 20, and 21. In the following explanation, about the components of the checkout machine 12 illustrated in FIG. 4, “-1” is appended to the reference numerals of the components of the master machine 12-1 and “-2” is appended to the reference numerals of the components of the satellite machine 12-2 to make it possible to identify the components.

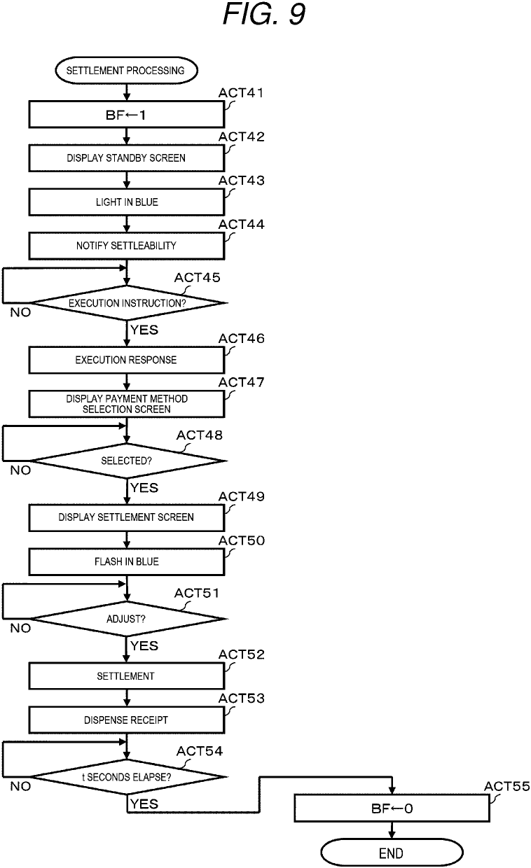

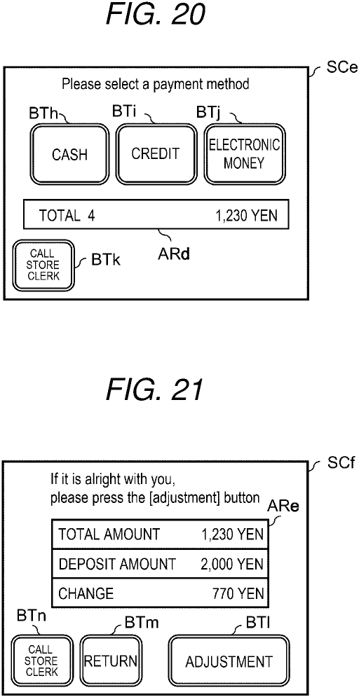

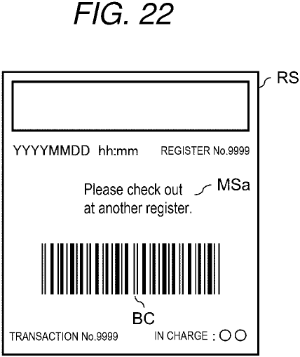

FIG. 8 is a flowchart illustrating a procedure of the second information processing executed by a processor 61-1 of the master machine 12-1 according to the settlement program. FIG. 9 is a flowchart illustrating a specific procedure of settlement processing. FIGS. 20 and 21 are examples of various screens SCe and SCf displayed on a touch panel 68-1, which is a display device of the master machine 12-1.

In ACT 31, the processor 61-1 waits for reception of a transaction file. If a transaction file transmitted from the registration machine 11 disposed in the same checkout lane is received by the communication unit 65-1, the processor 61-1 determines YES in ACT 31 and proceeds to ACT 32. In ACT 32, the processor 61-1 checks the busy flag BF.

If the busy flag BF is “1”, that is, the processor 61-1 is still executing settlement of the preceding customer, the processor 61-1 determines YES in ACT 32 and proceeds to ACT 33. In ACT 33, the processor 61-1 selects the checkout machine identified by a transfer destination ID set in a storing unit 631-1 and transmits the transaction file. That is, if, as a default, the checkout machine ID of the satellite machine 12-2 is set in the storing unit 631-1, the processor 61-1 sets the satellite machine 12-2 as a destination and controls the transmission of the transaction file accordingly. The transaction file is thus transmitted from the communication unit 65-1 to the satellite machine 12-2 via the network 15.

In ACT 34, the processor 61-1 checks whether the processor 61-1 succeeds in the transmission of the transaction file. If succeeding in the transmission of the transaction file, the processor 61-1 determines YES in ACT 34 and ends the second information processing.

If failing in the transmission of the transaction file, the processor 61-1 determines NO in ACT 34 and proceeds to ACT 35. In ACT 35, the processor 61-1 performs control to transmit a busy notification command to the registration machine 11. According to this control, as explained with reference to the sequence chart of FIG. 14, the busy notification command is transmitted from the master machine 12-1 to the registration machine 11. Then, the processor 61-1 ends the second information processing.

On the other hand, if a transaction file is received while the busy flag BF is “0”, that is, during idling when settlement processing is not being executed, the processor 61-1 determines NO in ACT 32 and proceeds to ACT 36. In ACT 36, the processor 61-1 executes the settlement processing.

That is, in ACT 41 in FIG. 9, the processor 61-1 changes the busy flag BF to “1”. In ACT 42, the processor 61-1 changes the screen of the touch panel 68-1 to a standby screen. The standby screen is a screen for displaying a message such as “Please wait for a while” and instructing the customer 22 to stand by for operation. Further, in ACT 43, the processor 61-1 lights the rotary beacon light 71 in blue.

If finishing the processing in ACT 41 to ACT 43, in ACT 44, the processor 61-1 performs control to transmit a settleability notification command to the registration machine 11. According to the control, as explained with reference to the sequence chart of FIG. 11, the settleability notification command is transmitted from the master machine 12-1 to the registration machine 11. The settleability notification command includes the checkout machine ID of the master machine 12-1. As a result, as explained above, in the registration machine 11, the checkout destination notification screen SCc including the message MSa for guiding the customer 22 to the master machine 12-1 is displayed.

In ACT 45, the processor 61-1 waits for an execution instruction command. If settleability notification command is received, in ACT 47, the processor 61-1 performs control to transmit an execution response command to the registration machine 11. In ACT 47, the processor 61-1 updates the screen of the touch panel 68-1 to a payment method selection screen SCe (see FIG. 20).

FIG. 20 is an example of the payment method selection screen SCe. The payment method selection screen SCe is a screen on which a total region ARd is arranged and icons of a cash button BTh, a credit button BTi, an electronic money button BTj, and a store clerk call button BTk are further arranged. The total region ARd is a region for displaying a total number of articles and a total amount included in a transaction file acquired from the registration machine 11. The cash button BTh is an operator that the customer 22 who selects cash as a payment method touches. The credit button BTi is an operator that the customer 22 who selects a credit card as the payment method touches. The electronic money button BTj is an operator that the customer 22 who selects electronic money as the payment method touches. The store clerk call button BTk is an operator that the customer 22 touches in order to call a store clerk.

The cash button BTh, the credit button BTi, and the electronic money button BTj permit selecting of a payment method. Payment methods ARe not limited to three types of the cash, the credit card, and the electronic money. The payment methods may be any two types or another payment method may be selectable. The payment methods may be one type. In that case, an operator for instructing a settlement start, for example, an icon of a settlement start button may be displayed on the payment method selection screen SCe instead of the cash button BTh, the credit button BTi, and the electronic money button BTj.

The customer 22 to whom the master machine 12-1 is designated as a checkout destination by the store clerk 21 moves to a setting place of the master machine 12-1. If the payment method selection screen SCe is displayed on the touch panel 68-1 of the master machine 12-1, the customer 22 touches a button corresponding to a desired payment method. That is, a customer desiring cash payment touches the cash button BTh, a customer desiring credit card payment touches the credit button BTi, and a customer desiring electronic money payment touches the electronic money button BTj.

In ACT 48, the processor 61-1 waits for any payment method to be selected. If a payment method is selected, the processor 61-1 determines YES in ACT 48 and proceeds to ACT 49. In ACT 49, the processor 61-1 updates the screen of the touch panel 68-1 to a settlement screen SCf (see FIG. 21). In ACT 50, the processor 61-1 flashes the rotary beacon light 71 in blue.

FIG. 20 is the settlement screen SCf displayed if the cash is selected as the payment method. The settlement screen SCf is a screen on which a display region ARe for a total amount, a despot amount, and a change amount is arranged and icons of an adjustment button BTl, a return button BTm, and a store clerk call button BTn ARe further arranged. Although not illustrated, the icons of the adjustment button BTl, the return button BTm, and the store clerk call button BTn ARe also arranged on a settlement screen displayed if the credit card or the electronic money is selected as the payment method.

The customer 22 who touched the cash button BTh and declared to pay by cash deposits cash equal to or more than the total amount to an automatic change machine and, thereafter, touches the adjustment button BTl. The customer 22 who changes the payment method to a payment method other than the cash touches the return button BTm. If calling a store clerk, the customer 22 touches the store clerk call button BTn. If the return button BTm is touched, the screen of the touch panel 68-1 returns to the payment method selection screen SCe.

In ACT 51, the processor 61-1 waits for the adjustment button BTl to be touched. If the adjustment button BTl is touched, the processor 61-1 determines YES in ACT 51 and proceeds to ACT 52. In ACT 52, the processor 61-1 executes settlement of a transaction. If cash is selected as the payment method, the processor 61-1 executes processing of calculating change due and dispensing the change due from the automatic change machine. If a credit card is selected as the payment method, the processor 61-1 performs authentication of a credit card read by a reader-writer 70-1 and decides the total mount as a credit settlement amount on condition that the total amount is approved by the server 13. If electronic money is selected as the payment method, the processor 61-1 subtracts the total amount from the balance of an electronic money medium read by the reader-writer 70-1.

After the settlement of the transaction is completed by any of the available methods, the processor 61-1 controls a printer 69-1 and dispenses a transaction receipt as ACT 53. The settlement information 18, that is, the transaction number, the transaction date and time, the registration machine ID, the commodity sales data, the total number of articles, the total amount, and the like ARe printed on the transaction receipt.

In ACT 54, the processor 61-1 waits for t seconds to elapse. The time of t seconds is a time estimated to be required by the customer 22 receiving the transaction receipt to go away from the checkout machine 12. The time of t seconds can be any time set by an administrator of the system and is preferably approximately 10 seconds.

If t seconds elapse, the processor 61-1 determines YES in ACT 54 and proceeds to ACT 55. In ACT 55, the processor 61-1 returns the busy flag BF to “0”. Then, the processor 61-1 ends the second information processing.

In this way, the processor 61-1 of the master machine 12-1 realizes the function of the first settling unit 611 according to the processing in ACT 31, ACT 32, and ACT 36. The processor 61-1 realizes the function of the transferring unit 612 according to the processing in ACT 31, ACT 32, and ACT 33.

With these functions, if receiving a transaction file from the registration machine 11 in the same checkout lane via the network 15 in a state in which settlement processing is executable, the master machine 12-1 executes the settlement processing based on the settlement information 18 described in the transaction file. If receiving a transaction file from the registration machine 11 in the same checkout lane in a state in which settlement is not possible, the master machine 12-1 transmits the transaction file to another checkout machine, that is, the satellite machine 12-2 in the same checkout lane connected by a network.

Subsequently, a main operation of the satellite machine 12-2 to which a transaction file is transmitted from the master machine 12-1 is explained with reference to FIG. 10. FIG. 10 is a flowchart illustrating a procedure of the third information processing executed by a processor 61-2 of the satellite machine 12-2 according to the settlement program.

In ACT 61, the processor 61-2 waits for reception of a transaction file. If a transaction file transmitted from the master machine 12-1 disposed in the same checkout lane is received by a communication unit 65-2, the processor 61-2 determines YES in ACT 61 and proceeds to ACT 62. In ACT 62, the processor 61-2 checks the busy flag BF.

If the busy flag BF if “1”, that is, the processor 61-2 is processing settlement of the preceding customer, the processor 61-2 determines YES in ACT 62 and proceeds to ACT 63. In ACT 63, the processor 61-2 performs control to transmit a busy notification command to the registration machine 11. According to the control, as explained with reference to the sequence chart of FIG. 13, the busy notification command is transmitted from the satellite machine 12-2 to the registration machine 11. Then, the processor 61-2 ends the third information processing.

On the other hand, if a transaction file is received while the busy flag BF is “0”, that is, during idling when settlement processing is not executed, the processor 61-2 determines NO in ACT 62 and proceeds to ACT 64. In ACT 64, the processor 61-2 executes the settlement processing.

The settlement processing is executed in the same procedure as the settlement processing of the master machine 12-1 explained with reference to FIG. 9. That is, in ACT 41, the processor 61-2 changes the busy flag BF to “1”. In ACT 42, the processor 61-2 changes a screen of a touch panel 68-2 to a standby screen. Further, in ACT 43, the processor 61-2 lights the rotary beacon light 71 in blue.

If finishing the processing in ACT 41 to ACT 43, in ACT 44, the processor 61-2 performs control to transmit a settleability notification command to the registration machine 11. According to the control, as explained with reference to the sequence chart of FIG. 12, the settleability notification command is transmitted from the satellite machine 12-2 to the registration machine 11. The settleability notification command includes the checkout machine ID of the satellite machine 12-2. As a result, as explained above, in the registration machine 11, the checkout destination notification screen SCc including the message MSa for guiding the customer 22 to the satellite machine 12-2 is displayed.

In ACT 45, the processor 61-2 that transmitted the settleability notification command waits for an execution instruction command. If receiving the execution instruction command from the registration machine 11, in ACT 47, the processor 61-2 performs control to transmit an execution response command to the registration machine 11. In ACT 47, the processor 61-2 updates the screen of the touch panel 68-2 to the payment method selection screen SCe.

In ACT 48, the processor 61-2 that controlled the display of the payment method selection screen SCe waits for any payment method to be selected. If a payment method is selected, the in ACT 49, the processor 61-2 updates the screen of the touch panel 68-2 to the settlement screen SCf. In ACT 50, the processor 61-2 flashes the rotary beacon light 71 in blue.

In ACT 51, the processor 61-2 that finished the processing in ACT 49 and ACT 50 waits for the adjustment button BT1 to be touched. If the adjustment button BT1 is touched, in ACT 52, the processor 61-2 executes settlement of a transaction. If the settlement of the transaction ends, in ACT 53, the processor 61-2 controls the printer 69-2 and dispenses a transaction receipt.

Thereafter, in ACT 54, the processor 61-2 waits for t seconds to elapse. If t seconds elapse, in ACT 55, the processor 61-2 returns the busy flag BF to “0”. Then, the processor 61-2 ends the third information processing.

In this way, the processor 61-2 of the satellite machine 12-2 realizes the function of the second settling unit 613 according to the processing in ACT 61, ACT 62, and ACT 64.

Consequently, under an environment in which the master machine 12-1 can normally receive the transaction file from the registration machine 11, the transaction processing system 10 can cause the two checkout machines 12, that is, the master machine 12-1 and the satellite machine 12-2 to efficiently operate and settle many transactions in a short time.

On the other hand, under an environment in which the master machine 12-1 cannot normally receive the transaction file, the transmission error screen SCd is displayed in the registration machine 11. If check operation by the store clerk 21 is performed concerning the transmission error, the error receipt RS is dispensed. The transaction file turned out to be the transmission error is saved in the retaining file 17 of the server 13.

The store clerk 21 who checked the transmission error screen SCd hands the error receipt RS to the customer 22 who is a target of the transaction file turned out to be the transmission error. The store clerk 21 instructs the customer 22 to perform checkout in another register. For example, if the satellite machine 12-2 in the same checkout lane is not in use, the store clerk 21 instructs the customer 22 to perform settlement using the error receipt RS in the satellite machine 12-2.

The customer 22 receiving the instruction moves to a setting place of the satellite machine 12-2. The customer 22 operates the scanner 67 to scan the barcode BC of the error receipt RS.

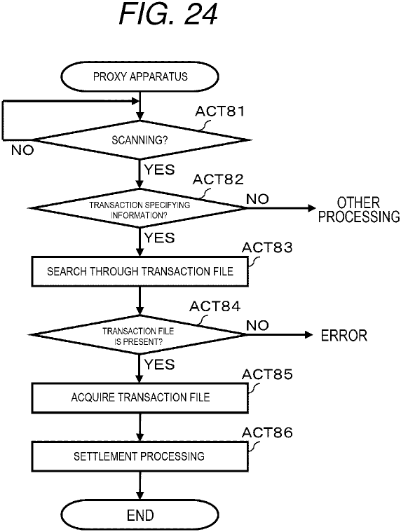

FIG. 23 is a flowchart illustrating a procedure of the fourth information processing executed by the processor 61-2 of the satellite machine 12-2 according to the settlement program. In ACT 71, the processor 61-2 waits for a barcode to be scanned. If a barcode is scanned by the scanner 67, the processor 61-2 determines YES in ACT 71 and proceeds to ACT 72. In ACT 72, the processor 61-2 checks the busy flag BF.

If the busy flag BF is “1”, that is, settlement is executed, the processor 61-2 determines YES in ACT 72. The processor 61-2 determines that the scanning of the barcode is an error. In this way, the fourth information processing cannot be executed in the satellite machine 12-2 that is executing the settlement.

If the busy flag BF is “0”, that is, during idling when settlement processing is not executed, the processor 61-2 determines NO in ACT 72 and proceeds to ACT 73. In ACT 73, the processor 61-2 checks whether the barcode is the barcode BC of the transaction specifying information printed on the error receipt RS. If a barcode other than the barcode BC of the transaction specifying information is scanned, the processor 61-2 executes other processing based on data of the barcode. The other processing is not particularly limited.

If the barcode BC of the transaction specifying information is scanned, the processor 61-2 determines YES in ACT 73 and proceeds to ACT 74. In ACT 74, the processor 61-2 accesses the server 13 connected via the network 15 and searches through the retaining file 17. In ACT 75, the processor 61-2 determines presence or absence of a transaction file describing the settlement information 18 specified by the transaction specifying information. If the relevant transaction file is not saved in the retaining file 17, the processor 61-2 determines NO in ACT 75. The processor 61-2 determines that the scanning of the barcode is an error.

In contrast, if the relevant transaction file is saved in the retaining file 17, the processor 61-2 determines YES in ACT 75 and proceeds to ACT 76. In ACT 76, the processor 61-2 acquires the transaction file from the retaining file 17. In ACT 77, the processor 61-2 executes the settlement processing based on settlement information described in the transaction file. Then, the processor 61-2 ends the fourth information processing.

In this way, the processor 61-2 of the satellite machine 12-2 realizes the function of the reading unit 614 by executing the processing in ACT 71 in cooperation with a scanner 67-2. The processor 61-2 realizes the function of the acquiring unit 615 according to the processing in ACT 74 to ACT 76. The processor 61-2 realizes the function of the third settling unit 616 according to the processing in ACT 77.

Consequently, even if the transaction file cannot be transmitted to the master machine 12-1, the customer 22 can settle the transaction by operating the scanner 67-2 of the satellite machine 12-2 and scanning the barcode BC of the error receipt RS.

On the other hand, if the satellite machine 12-2 in the same checkout lane is in use when the transmission error screen SCd is checked, the store clerk 21 instructs the customer 22 to perform settlement using the error receipt RS in the proxy apparatus 14 set in the service counter.

The customer 22 receiving the instruction moves to a setting place of the proxy apparatus 14. The customer 22 operates the scanner 88 and scans the barcode BC of the error receipt RS.

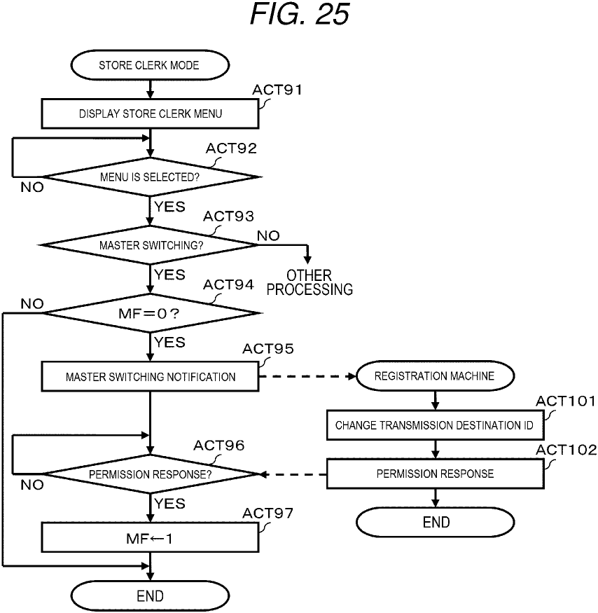

FIG. 24 is a flowchart illustrating a procedure of the sixth information processing executed by the processor 81 of the proxy apparatus 14 according to the proxy program. In ACT 81, the processor 81 waits for a barcode to be scanned. If a barcode is scanned by the scanner 88, the processor 81 determines YES in ACT 81 and proceeds to ACT 82. In ACT 82 the processor 81 checks whether the barcode is the barcode BC of the transaction specifying information printed on the error receipt RS. If a barcode other than the barcode BC of the transaction specifying information is scanned, the processor 81 executes other processing based on data of the barcode. The other processing is not particularly limited.

If the barcode BC of the transaction specifying information is scanned, the processor 81 determines YES in ACT 82 and proceeds to ACT 83. In ACT 83, the processor 81 accesses the server 13 connected via the network 15 and searches through the retaining file 17. In ACT 84, the processor 81 determines presence or absence of a transaction file describing the settlement information 18 specified by the transaction specifying information. If the relevant transaction file is not saved in the retaining file 17, the processor 81 determines NO in ACT 84. The processor 81 determines that the scanning of the barcode is an error.

In contrast, if the relevant transaction file is saved in the retaining file 17, the processor 81 determines YES in ACT 84 and proceeds to ACT 85. In ACT 85, the processor 81 acquires the transaction file from the retaining file 17. In ACT 86, the processor 81 executes settlement processing based on the settlement information described in the transaction file. That is, the processor 81 executes the processing in ACT 47 to ACT 49 and ACT 51 to ACT 53 illustrated in FIG. 9 in order. Then, the processor 81 ends the sixth information processing.

In this way, the processor 81 of the proxy apparatus 14 realizes the function of the reading unit 811 by executing the processing in ACT 81 in cooperation with the scanner 88. The processor 81 realizes the function of the acquiring unit 812 according to the processing in ACT 83 to ACT 85. The processor 81 realizes the function of the settling unit 813 according to the processing in ACT 86.

Consequently, even if the transmission file cannot be transmitted to the master machine 12-1, the customer 22 can settle the transaction by operating the scanner 88 of the proxy apparatus 14 and scanning the barcode BC of the error receipt RS.

If a state in which the transaction file cannot be transmitted from the registration machine 11 to the master machine 12-1 continues for a long time, the error receipt RS must be repeatedly handed to the customers 22 so the settlement can be processed at the satellite machine 12-2 or the proxy apparatus 14. Therefore, a solution is desired for longer outages or the like. Accordingly, as a solution, the transaction processing system 10 makes it possible to manually switch a transmission destination of the transaction file from the master machine 12-1 to the satellite machine 12-2.

Specifically, if a barcode of the store clerk ID is scanned by the scanner 67 while in an idle state, the checkout machine 12 changes to a store clerk mode. A master switching job is set in jobs executable in the store clerk mode.

FIG. 25 is a flowchart illustrating a procedure of the fifth information processing executed by the processor 61-2 of the satellite machine 12-2 according to the settlement program if the store clerk mode is set.

Upon entering the store clerk mode, in ACT 91, the processor 61-2 causes the touch panel 68-2 to display a job menu screen for store clerks. In ACT 92, the processor 61-2 waits for any job menu to be selected. If a job menu is selected, the processor 61-2 determines YES in ACT 92 and proceeds to ACT 93. In ACT 93, the processor 61-2 checks whether the selected job menu is for the master switching job. If the selected job menu is not for the master switching job, the processor 61-2 determines NO in ACT 93 and executes other processing corresponding to the selected job. The other processing is not particularly limited.

If the master switching job is selected, the processor 61-2 determines YES in ACT 93 and proceeds to ACT 94. In ACT 94, the processor 61-2 checks the mode flag MF. If the mode flag MF is “1”, the satellite machine 12-2 is already switched from the satellite mode to the master mode. Therefore, the processor 61-2 determines NO in ACT 94 and ends the fifth information processing.

On the other hand, if the mode flag MF is “0”, the processor 61-2 determines YES in ACT 94 and proceeds to ACT 95. In ACT 95, the processor 61-2 performs control to transmit a master notification command to the registration machine 11 disposed in the same checkout lane. According to the control, the master notification command is transmitted from the communication unit 65-2 to the registration machine 11 via the network 15. The master notification command includes the checkout machine ID of the satellite machine 12-2.

In ACT 101 in FIG. 25, the processor 31 of the registration machine 11 receiving the master notification command changes the transmission destination ID stored in the storing unit 331 from the checkout machine ID of the master machine 12-1 to the checkout machine ID included in the master notification command, that is, the checkout machine ID of the satellite machine 12-2. In ACT 102, the processor 31 performs control to transmit a permission response command to the satellite machine 12-2. According to the control, the permission response command is transmitted from the registration machine 11 to the satellite machine 12-2 via the network 15.

In ACT 96, the processor 61-2 waits for the permission response command. After receiving the permission response command, the processor 61-2 determines YES in ACT 96 and proceeds to ACT 97. In ACT 97, the processor 61-2 changes the mode flag MF to “1”. Then, the processor 61-2 ends the fifth information processing.

In this way, the processor 61-2 realizes the function of the instructing unit 617 according to the processing in ACT 95. The processor 61-2 realizes the function of the updating unit 618 according to the processing in ACT 97.

If the transmission destination ID is changed from the checkout machine ID of the master machine 12-1 to the checkout machine ID of the satellite machine 12-2 in the registration machine 11, thereafter, the transaction file is transmitted from the registration machine 11 to the satellite machine 12-2. At this time, the processor 61-2 of the satellite machine 12-2 executes the third information processing explained with reference to the flowchart of FIG. 10. Therefore, the processor 61-2 realizes the function of the fourth settling unit 619 according to the processing in ACT 64 in FIG. 10.

Consequently, even if a failure or the like occurs in the master machine 12-1 and the transaction file fails to be received from the registration machine 11, the transmission destination of the transaction file can be quickly changed from the master machine 12-1 to the satellite machine 12-2 by simple operation.

The rotary beacon light 71 included in the master machine 12-1 or the satellite machine 12-2 is lit in blue until the transaction file is received from the registration machine 11 or the master machine 12-1. The lighting state (e.g., continuously lit) is maintained even at a stage when the transaction file is received. After the customer 22 touches the payment method selection screen SCe, the blue light changes to flashing.

In this way, the rotary beacon light 71 maintains its lighting state after the transaction file is receives and switches to a flashing state only once the customer 22 starts the operation (interacts with the payment method selection screen SCe). Therefore, when the rotary beacon light 71 changes to the flashing state, the store clerk 21 at the registration machine 11, can see that the customer 22 has started operating the checkout machine 12.

### Modifications of the Transaction Processing System

The number of checkout machines 12 disposed in one checkout lane is not limited to two. Three or more checkout machines 12 may be disposed in one checkout lane. In this case, one checkout machine 12 is set as the master machine 12-1 and the remaining checkout machines 12 ARe set as satellite machines 12-2. Transfer order of a transaction file can be preset for the satellite machines 12-2. That is, the master machine 12-1 stores, in the storing unit 631, a checkout machine ID of the satellite machine 12-2 that is first in the transfer order. The satellite machine 12-2 that is first in the transfer order stores, in the storing unit 631, a checkout machine ID of the satellite machine 12-2 that is second in the transfer order. The satellite machine 12-2 that is the lowest in the transfer order stores a null value in the storing unit 631. Even in a transaction processing system having such a configuration, aspects of the present embodiment can be applied.

The medium in which the transaction specifying information is recorded by the recording unit 313 is not limited to the receipt paper. The transaction specifying information may be recorded in a portable recording medium, such as a USB (Universal Serial Bus) memory or an SD Card and handed to a customer. The transaction identification information need not be represented in the form of the barcode. For example, the transaction identification information may be represented by a two-dimensional code. If another register, for example, the proxy apparatus 14 has an optical character recognition (OCR) function, the transaction identification information may be recorded in a text format.

A setting place of the proxy apparatus 14 is not limited to the service counter. A normal POS terminal set in a face-to-face register can also be used as a proxy apparatus.

In the checkout machine 12, the functions of the reading unit 614 and the acquiring unit 615 may be omitted from among the functions realized by the processor 61. That is, the satellite machine 12-2 can be excluded as a choice of another register.

A busy state in which the busy flag BF is “1” is not limited to just during the execution of the settlement processing. For example, the busy flag BF may be set to “1” to indicate busy state if the receipt paper of the printer 69 runs out.

In an embodiment, if receiving the transaction file in the settleable state, the checkout machine 12 displays the payment method selection screen SCe. As another embodiment, the checkout machine 12 displays a guidance screen for urging the customer 22 to perform operation if the transaction file is received while in the settleable state. The payment method selection screen SCe may be displayed after the customer 22 touches the guidance screen. In this case, the rotary beacon light 71 only has to be changed from the lighted state to the flashing state according to the touch on the guidance screen.

The rotary beacon light 71 need not be changed from the lighted state to the flashing state and in other examples may be changed from the flashing state to the lighted state. An operation start of the customer 22 may be notified to the operator by changing a light (lamp) color.

The procedure of the fifth information processing executed by the processor of the satellite machine 12-2 may be controlled not by the settlement program but by another program.

The retaining file 17 may be in the registration machine 11 rather than the server 13. In this case, the registration machines 11 in the checkout lanes each respectively include the retaining files 17 and save transaction files for the checkout lanes. Alternatively, any one registration machine 11 may include the retaining file 17 and collectively save the transaction files for the checkout lanes.

While certain embodiments have been described, these embodiments have been presented by way of example only, and ARe not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents ARe intended to cover such forms or modifications as would fall within the scope and spirit of the inventions.

What is claimed is:

1. A transaction processing system with customer-operated settlement apparatuses, the system comprising:
a clerk-operated register machine; and
a plurality of settlement apparatuses connectable to the clerk-operated register machine via a network, the plurality of settlement apparatuses including a first settlement apparatus and a second settlement apparatus, wherein:
the first settlement apparatus is configured to:
receive settlement information from the clerk-operated register machine,
perform settlement processing according to the received settlement information when the first settlement apparatus is available for settlement processing, and
transfer the received settlement information to the second settlement apparatus when the first settlement apparatus is unavailable for settlement processing; and
the second settlement apparatus is configured to:
receive the settlement information transferred by the first settlement apparatus,
perform settlement processing according to the transferred settlement information when the second settlement apparatus is available for settlement processing, and
transmit a busy notification to the clerk-operated register machine if the settlement information is transferred from the first settlement apparatus and the second settlement apparatus is unavailable for settlement processing.

2. The transaction processing system according to claim 1, wherein the second settlement apparatus is further configured to, when in an administrator mode, send an instruction to the clerk-operated register machine to switch a default transmission destination from the first settlement apparatus to the second settlement apparatus.

3. The transaction processing system according to claim 1, further comprising:
a proxy settlement device connected to the clerk-operated register machine via the network, wherein
the clerk-operated register machine is configured to transmit settlement information to the proxy settlement device.

4. The transaction processing system according to claim 1, wherein each settlement apparatus stores information indicating whether the settlement apparatus is a master device or a satellite device.

5. The transaction processing system according to claim 4, wherein each settlement apparatus further stores information indicating the next settlement apparatus in the plurality to which the settlement information is to be transferred if the transferring settlement apparatus is presently unavailable for settlement processing.

6. The transaction processing system according to claim 1, wherein the first settlement apparatus is further configured to transmit a busy notification to the clerk-operated register machine if a transmission of settlement information to the second settlement apparatus from the first settlement apparatus fails.

7. A transaction settlement apparatus, comprising:
a communication interface connectable, via a network, to a clerk-operated register machine and at least one other transaction settlement apparatus; and
a processor configured to operate as a master device or a satellite device, wherein
when operating as the master device, the processor is configured to:
receive settlement information from the clerk-operated register machine,
perform settlement processing according to the received settlement information when available for settlement processing, and
transfer the received settlement information to another settlement apparatus when unavailable for settlement processing; and
when operating as the satellite device, the processor is configured to:
receive the settlement information transferred from another settlement apparatus,
perform settlement processing according to the transferred settlement information when available for settlement processing, and
transmit a busy notification to the clerk-operated register machine if unavailable for settlement processing when the settlement information is transferred from another settlement apparatus.

8. The transaction settlement apparatus according to claim 7, wherein the processor is further configured to, when in an administrator mode, send an instruction to the clerk-operated register machine to switch a default transmission destination for settlement information.

9. The transaction settlement apparatus according to claim 7, further comprising:
a storage unit that stores information indicating whether the settlement apparatus is operating as the master device or the satellite device.

10. The transaction settlement apparatus according to claim 9, wherein the storage unit additionally stores information indicating the next transaction settlement apparatus to which the settlement information is to be transferred.

11. The transaction settlement apparatus according to claim 7, wherein the processor of the master device is further configured to transmit a busy notification to the clerk-operated register machine if a transmission of settlement information to another transaction settlement apparatus fails.

12. The transaction settlement apparatus according to claim 7, further comprising:
a lamp positioned to be visible from the clerk-operated register machine.

13. The transaction settlement apparatus according to claim 12, further comprising:
a display screen, wherein
the processor is configured to:
cause the display screen to display a payment method selection screen, and
cause the lamp to flicker after a payment method displayed on the payment selection screen has been selected.

14. The transaction settlement apparatus according to claim 7, further comprising:
a display screen, wherein
the processor is configured to:
cause the display screen to display a payment method selection screen after the settlement information is received.

15. A non-transitory, computer-readable storage medium storing program instructions which when executed by a transaction settlement apparatus cause the transaction settlement apparatus to perform a method comprising:
when operating as a master device in a transaction settlement system:
receive settlement information from a clerk-operated register machine,
perform settlement processing according to the received settlement information when available for settlement processing, and
transfer the received settlement information to another settlement apparatus when unavailable for settlement processing; and
when operating as a satellite device in the transaction settlement system:
receive the settlement information transferred from another settlement apparatus,
perform settlement processing according to the transferred settlement information when available for settlement processing and,
transmit a busy notification to the clerk-operated register machine if unavailable for settlement processing when the settlement information is transferred from another settlement apparatus.

16. The non-transitory, computer-readable storage medium according to claim 15, wherein the method further comprises:
when in an administrator mode, send an instruction to the clerk-operated register machine to switch a default transmission destination for settlement information.

17. The non-transitory, computer-readable storage medium according to claim 15, wherein the method further comprises:
checking a storage unit that stores information indicating whether the transaction settlement apparatus is operating as the master device or the satellite device.

18. The non-transitory, computer-readable storage medium according to claim 15, wherein the transaction settlement apparatus is further configured to transmit a busy notification to the clerk-operated register machine if a transmission of settlement information to another transaction settlement apparatus fails.

19. The non-transitory, computer-readable storage medium according to claim 15, wherein the method further comprises:
cause a display screen to display a payment method selection screen, and
cause a lamp to flicker after a payment method displayed on the payment selection screen has been selected.

20. The non-transitory, computer-readable storage medium according to claim 15, wherein the method further comprises:
cause a display screen to display a payment method selection screen after the settlement information is received.
